(19) United States
(12) Patent Application Publication
(10) Pub. No.: US 2010/0203308 A1
(43) Pub. Date: Aug. 12, 2010

(54) Production of a flexible, gas-tight,and transparent composite film

(76) Inventors: Martin Mennig, Quierschied (DE); Peter Rogin, Sulzbach (DE); Markus Sauer, Saarbruecken (DE)

Correspondence Address: COLLARD & ROE, P.C., 1077 NORTHERN BOULEVARD, ROSLYN, NY, 11576, US

(21) Appl. No.: 12/311,563

(22) PCT Filed: Oct. 2, 2007
(86) PCT No.: PCT/EP2007/060454

§ 371 Date: May 13, 2009

(30) Foreign Application Priority Data
Oct. 4, 2006 (DE) 10-2006-046-961.5

(51) Int. Cl. B32B 17/04; C03B 29/00

(52) U.S. Cl. 428/220; 156/89.12

(57) ABSTRACT

The invention relates to a method for the production of a flexible, gas-tight, and transparent composite film, comprising a transparent carrier layer made of plastic and a glass-like layer. The method comprises the following steps: a) a temperature-resistant substrate is coated with a lacquer comprising glass or glass-forming pre-stages by a wet chemical process, b) the coating is thermally compressed to form the glass-like layer, c) the transparent carrier layer made of plastic is applied onto the glass-like layer and bonded thereto, and d) the composite of the carrier layer and the glass-like layer is separated from the substrate. The composite films obtained in this way are suitable as encapsulation material or packing material, particularly for the use in displays, illumination and photovoltaics, for example for light-emitting diodes, solar cells, displays, or electronic circuits.

The present invention relates to a method for the production of a flexible, gas-tight, and transparent composite film, comprising a transparent carrier layer made of plastic and a glass-like layer, the produced transparent composite film and its application.

For many applications it is desirable to apply electronic and optical-electronic components and assemblies to flexible and transparent substrates. Major examples are flexible displays and in particular those that are based on organic light-emitting diodes, or solar cells. However, the above-mentioned components are often sensitive to attacks by steam or atmospheric oxygen, so that the substrate must also have a barrier effect against such substances. The gas permeability of typical polymer films is excessively high. Glass on the other hand, which has an excellent barrier effect, is either inflexible when the layer thickness is in the mm-range, or too sensitive as thin glass.

Barrier films on a purely organic basis are used for example for food packaging. US-A-20040033379, for example, discloses such barrier systems, where several layers of various polymers are combined that complement each other in terms of their permeation and other properties. The barrier effect of such systems is however limited due to the inherent permeability of even the best polymers.

Therefore, transparent inorganic layers have been used for a long time now to improve the barrier effect. Oxides, such as SiOₓ, Al₂O₃ or Si₃N₄ are applied in gas-phase processes, such as sputtering or chemical vapor deposition. Typically, these layers are covered with polymer layers, as described for example in GB-A-1086482. This covering serves, on the one hand, for mechanical protection and, on the other hand, it also improves the barrier effect by sealing defects than cannot be completely avoided.

The barrier effect can be further improved by applying several inorganic layers that are separated by organic intermediate layers. As described for example in U.S. Pat. No. 6,497,598 or in DE-A-102004005313, the organic intermediate layers can also be deposited in gas phase processes in order to avoid switching between various process technologies.

WO-A-2005006441 describes an inorganic multi-layer barrier system where the individual layers are alternately comprised of silicon oxide and silicon nitride. US-A-20040012747, for example, suggests diamond-like carbon to be the barrier layer in displays that are based on inorganic light-emitting diodes.

All barrier layers mentioned so far are produced in gas-phase processes at low pressure. However, the process technology required in that case involves great effort and is difficult to combine with wet-chemical procedures within one and the same system that is used to apply other layers and elements, such as organic light-emitting diodes.

DE-A-1955853 and EP-A-1137607 describe procedures that are based on thin glass, which is laminated onto a polymer carrier or coated with a polymer. The thickness of the thin glass used lies, however, in a range of 10 μm or more, so that the glass layer may break within the composite even at low bending radii, despite the polymer film. Moreover, the risk of breakage before or during application of the polymer layer is extremely high when using very thin glass films, which means that such processes are difficult to control.

The use of glass powder suspensions for producing glass layers is described for example in U.S. Pat. No. 5,639,325. However, this procedure requires high temperatures in order to compress the layers, which means that transparent plastic substrates cannot be used.

The object of the present invention is thus to provide a method for the production of a flexible, gas-tight, and colorless transparent composite film, comprising a transparent polymer film as substrate and a transparent barrier layer, allowing for combining the mechanical properties of a polymer film and the barrier properties of glass substrates. Moreover, the method should also be cost-effective and usable as a continuous process, if necessary.

Surprisingly, it was possible to solve this task with a method for the production of a composite film, where a lacquer comprising glass or glass-forming pre-stages is first applied onto a temperature-resistant substrate by a wet chemical process where it is thermally compressed, and then the polymer carrier layer is applied onto the thus-formed glass-like layer and after that the so formed composite is again separated from the temperature-resistant substrate.

The object of the present invention is thus a method for the production of a composite film, comprising a transparent carrier layer made of plastic and a glass-like layer, wherein a) a temperature-resistant substrate is coated with a lacquer comprising glass or glass-forming pre-stages by a wet chemical process, b) the coating is thermally compressed to form the glass-like layer, c) the transparent carrier layer made of plastic is applied onto the glass-like layer and bonded thereto, and d) the composite of the carrier layer and the glass-like layer is separated from the substrate.

Unlike prior art, this invention uses wet chemical coating processes for applying glass layers or glass-like layers. The production of such layers by sol-gel processes and related methods is known for a multitude of applications. This way, composite films can be produced from a thin glass layer on a polymer carrier in a simple and thus cost-effective manner, which combines both the mechanical flexibility and robustness of polymer films and the barrier effect of glass. By using a wet chemical process, complicated gas-phase processes and the use of thin glass, which is difficult to handle because of its proneness to breakage, can be avoided. This method can be easily designed as a continuous process.

Production comprises three major steps. First, the glass-like layer is applied onto a temperature-resistant substrate as a wet chemical coating, which is then thermally compressed. Then the polymer carrier film is applied by way of coating or laminating before the bond between the temperature-resistant substrate and the composite film is undone in a last step. Below is a detailed description of the invention.

The temperature-resistant substrate can be a rigid or a flexible substrate, e.g. in form of a plate or panel, a roller or film. In this case, temperature-resistant means, that it is resistant to the temperatures required for thermally compressing the glass-like layer.

Suitable substrate material can be any material that is sufficiently resistant to temperature, e.g. a substrate made of metal or metal alloys, glass, ceramics, glass ceramics or high temperature resistant plastic. In this case, high temperature resistant means temperature resistant in the above sense. Examples of metal or metal alloys may be steel, including stainless steel, chrome, copper, titanium, tin, zinc, aluminum, and brass. Examples of glass may be soda-lime glass, borosilicate glass, lead glass and silica glass. Ceramics may be, for example, ceramics that are based on oxides, such as SiO₂, Al₂O₃, ZrO₂, TiO₂ or MgO or on the respective mixed oxides. Examples of high temperature resistant plastic may be polyimide and polybenzimidazole (PBI).

Suitable substrate material may be, for example, a high temperature resistant polymer film, preferably a polyimide film, or a metal film, such as an aluminum, steel, or copper film. Rigid substrates may be, for example, metal plates or sheet panels or—which is to be preferred for continuous processes—rollers made of metal or ceramic material.

The substrate may be pre-treated or comprises at least one surface coating, which may be a plating, enameling, a glass or ceramic layer or a lacquering or paint coating. What also needs to be mentioned are the coatings that are applied in a gas-phase process, such as a diamond or TiN layer that is applied by chemical vapor deposition (CVD).

The substrate may, in particular, be covered with one or several function coatings that serve to improve wetting with the glass-like material or to facilitate separation of the composite from the substrate. Such function coatings are common and known to a person skilled in the art. Examples of such function coatings are the tin coating of tinplate or copper foil as adhesion reducers, nanoparticulate SiO₂ layers on polyimide film also for adhesion reduction, or nanoparticulate hydroxylapatite layers on polyimide film for improved wetting. To apply these function coatings, any method known to a person skilled in the art that suits the respective substrate and coating system may be used.

In a first step, lacquer comprising glass or glass-forming pre-stages is applied onto the temperature-resistant substrate by a wet chemical process, which is then thermally compressed. The lacquer comprising glass or glass-forming pre-stages is applied onto the temperature-resistant substrate by a wet chemical process, i.e. the lacquer is liquid. Viscosity can be set as needed in accordance with the coating method, as is known to a person skilled in the art. Preferably, a sol-gel layer will be applied or a low-melting glass composition in form of a suspension or true solution, such as sodium silicate, which will form a glass-like layer or glass layer after thermal compression.

The glass contained in the lacquer may be present in any convenient form, for example as flakes powder. A soluble glass composition may also be used. In general, glass will already, at least essentially, have the composition that is desired for the glass-like layer. However, mixtures of glasses of different compositions may also be used, or one or more glasses can be used together with glass-forming pre-stages, so that the composition of the glass-like layer results from the combination.

The glass or glass-like layer contained in the lacquer may be a glass or glass layer or glass-like layer of any glass composition known to a person skilled in the art. Preferably, it will be a composition with a relatively low melting point range so that complete compression is possible at temperatures that will not damage the substrate used.

As is generally known, the composition of glasses or glass-like layers usually comprises oxides of one or most often several metals or semimetals. A differentiation is generally made between network formers, network modifiers, and intermediate compounds. Network formers are, for example, oxides of Si, Ge, B, P, As, Sb, V. Network modifiers and intermediate compounds are, for example, oxides of alkali metals, such as Li, Na, K, Rb and Cs, of alkaline earth metals, such as Mg, Ca, Sr and Ba, Ga, In, Sc, Y, La, Sn, Pb, Al, Be, Zn, Cd, Ti, Zr, Ce, Bi, Mo, W, Fe and Th. Corresponding oxides are, for example, SiO₂, GeO₂, B₂O₃, P₂O₅, As₂O₅, Sb₂O₅, V₂O₅, Li₂O, Na₂O, K₂O, Rb₂O, Cs₂O, MgO, CaO, SrO, BaO, Ga₂O₃, In₂O₃, Sc₂O₃, Y₂O₃, La₂O₃, SnO₂, PbO₂, Al₂O₃, PbO, BeO, ZnO, CdO, TiO₂, ZrO₂, ThO₂ and oxides of Mo, W, Ce and Fe.

The properties of the various glasses vary depending on the components present and their relation to each other within the compositions. The glass contained in the lacquer or rather the glass-like layers according to the present invention may be purely inorganic or even organically modified inorganic layers of such oxides. The organically modified glasses or glass-like layers contain organic groups in the networks that are bonded to the metals or semimetals contained in the network. Aside from that, the glass-like layer may also include additives or the decomposition products of additives that may have been added to the lacquer.

Such glasses or glass-like layers are known to prior art and a person skilled in the art knows their compositions and methods for producing them. The invention preferably uses glasses or glass-like layers consisting of low-melting compositions, in particular glass solders of any kind. Sodium silicates are also suited and can be used as true solutions of glass compositions. Sodium silicate is normally a water-soluble alkali silicate, especially of sodium and/or potassium.

Glass solders are commercially available, easily melting glasses that are being used, among other things, to compound glasses with each other or with other materials. What is suited, for example, are glass solders that are based on lead borate, such as the commercially available glass solder named G018-085 by Schott. If silicate glasses are being employed, one should preferably use silicate glasses with a high alkali content (alkali silicates, such as sodium or potassium silicates), high boron content or high heavy metal content, such as lead or bismuth. Pure borate or phosphate glasses may also be used. Other preferable glass-like layers include organically modified inorganic glasses.

The lacquer may contain glass-forming pre-stages instead of, or possibly even in addition to glass. The glass-forming pre-stages are compounds or species that form a glass-like layer during thermal compression. These glass-forming pre-stages are known to a person skilled in the art. This way, hydrolysable compounds of semimetals and metals can form hydrolysates and condensates through hydrolysis and condensation reactions, which will, with an increasing degree of condensation, form oxides that may ultimately form a glass-like layer during thermal compression if present in a suitable composition. All these pre-stages, which can, of course, also be achieved through other reactions, are suited as glass-forming pre-stages. The mixtures of the various components and their ratios that are required in each case to achieve a glass-like layer are known to a person skilled in the art.

The glass-forming pre-stages may be present in the lacquer e.g. in the form of dissolved compounds or species, or in the form of sols or dispersed particles. Suitable as glass-forming pre-stages are, for example, one or more hydrolysable compounds of metals or semimetals M, wherein M is, e.g., Si, Ge, B, P, As, Sb, V, Li, Na, K, Rb, Cs, Mg, Ca, Sr, Ba, Ga, In, Sc, Y, La, Sn, Pb, Al, Be, Zn, Cd, Ti, Zr, Ce, Bi, Mo, W, Fe or Th, hydrolysates, condensates or oxides thereof.

Examples of corresponding oxides are mentioned above. They may be present, e.g., in the form of particles and used in the form of a sol or dispersion.

Various types of such oxides, as for example SiO₂, are commercially available or can be produced with the sol-gel method described below. The size of the particles may be selected from a wide range. Suitable are, e.g., nanostructured particles, i.e. particles with an average particle diameter (d₅₀ value, volume average, quantified e.g. laseroptically with UPA (ultrafine particle analyzer), Leeds Northrup) of no more than 1,000 nm and preferably no more than 200 nm. However, larger particles may also be used.

The hydrolysable compounds may have, e.g., the general formula (I) MXₙ, wherein M is as defined above, X is equal or different and a hydrolysable group or OH, wherein two X groups may be replaced by one oxo group, and n corresponds to the valence of the element and may be, e.g., 1, 2, 3 or 4. The hydrolysable group X may be, for example, hydrogen, halogen (F, Cl, Br or I), alkoxy (preferably C₁₋₆-alkoxy, such as methoxy, ethoxy, n-propoxy, i-propoxy and butoxy), aryloxy (preferably C₆₋₁₀-aryloxy, such as phenoxy), acyloxy (preferably C₁₋₆-acyloxy, such as acetoxy or propionyloxy), alkylcarbonyl (preferably C₂₋₇-alkylcarbonyl, such as acetyl), amino, monoalkylamino or dialkylamino having preferably from 1 to 12, and in particular from 1 to 6 carbon atoms in the alkyl group(s). What can also be used are soluble salts, such as sulfates, nitrates, phosphates, or complexes of the above-defined metals or semimetals. If X is a polydentate ligand and/or multicharged anion, the stoichiometry between X and M will, of course, change accordingly. The soluble salts, complexes and hydroxides of the metals and semimetals M are also counted among the hydrolysable compounds. Preferably used hydrolysable compounds are alkoxides.

Examples of such hydrolysable compounds are tetraalkoxysilanes, such as tetramethoxysilane and tetraethoxysilane (TEOS), Al(OCH₃)₃, Al(OC₂H₅)₃, Al(O-n-C₃H₇)₃, Al(O-i-C₃H₇)₃, Al(O-n-C₄H₉)₃, Al(O-sec-C₄H₉)₃, AlCl₃, AlCl(OH)₂, Al(OC₂H₄OC₄H₉)₃, TiCl₄, TKOC₂H₅)₄, Ti(O-n-C₃H₇)₄, Ti(O-i-C₃H₇)₄, Ti(OC₄H₉)₄, Ti(2-ethylhexoxy)₄, ZrCl₄, Zr(OC₂H₅)₄, Zr(O-n-C₃H₇)₄, Zr(O-i-C₃H₇)₄, Zr(OC₄H₉)₄, ZrOCl₂, Zr(2-ethylhexoxy)₄, and Zr compounds which have complexing radicals, such as (β-diketone and (meth)acryloyl radicals, sodium methylate, potassium acetate, boric acid, BCl₃, B(OCH₃)₃, B(OC₂H₅)₃, SnCl₄, Sn(OCH₃)₄, Sn(OC₂H₅)₄, VOCl₃ and VO(OCH₃)₃, alkali and alkaline earth metal hydroxides and alkali and alkaline earth metal oxides.

The glass-forming pre-stages are used in such mixtures and ratios in order to achieve the desired glasses or glass-like layers, as defined above. The preferred compositions have also already been mentioned above. For example, if one wishes to produce alkali silicate glasses, alkali and alkaline earth metal hydroxides or oxides may be added in appropriate quantities in addition to the Si component. To produce heavy metal silicate glasses it may be advisable to add, for example, heavy metal salts or heavy metal oxides, such as lead oxides, lead salts or bismuth salts.

To produce heavy metal silicate glasses it may be appropriate to use, for example, hydrolysable compounds that contain non-hydrolysable groups and their hydrolysates and condensates as glass-forming pre-stages. Examples of the respective silane compounds are mentioned below. Of course, such hydrolysable compounds with non-hydrolysable groups can also be used in combination with other, already mentioned glass-forming pre-stages. If necessary, the contained organic groups may be burnt out during thermal compression in order to form purely inorganic glasses. It is also possible, however, that organic radicals—for example, the non-hydrolysable groups of the hydrolysable compound used—remain in the glass-like layer.

Usable hydrolysable silanes with a non-hydrolysable group have, e.g., the general formula (II) RₙSiX₄₋ₙ, wherein the X groups—which are equal to, or differing from each other—are hydrolysable groups or hydroxyl groups, the radicals R—which are equal to, or differing from each other—are non-hydrolysable groups, and n is 1, 2 or 3. The examples of X are the same as defined above for formula (I), whereby alkoxy groups are to be preferred, in particular methoxy and ethoxy. Examples of R are alkyl, alkenyl and alkynyl having preferably from 1 to 12, and in particular from 1 to 4 carbon atoms, as well as aryl, aralkyl and alkaryl having preferably from 6 to 10 carbon atoms. Concrete examples are methyl, ethyl, propyl and butyl, vinyl, allyl and propargyl, phenyl, tolyl and benzyl, and preferably alkyl trialkoxysilanes or dialkyl dialkoxysilanes, such as methyl tri(m)ethoxy silane and ethyl tri(m)ethoxy silane ((m)ethoxy=methoxy or ethoxy).

Hydrolysis and condensation of the hydrolysable compounds is preferably achieved by a sol-gel process under formation of the glass-forming pre-stages. In the sol-gel process, the hydrolysable compounds are usually hydrolyzed with water, optionally under acidic or basic catalysis, and optionally at least partially condensed. The hydrolysis and/or condensation reactions lead to the formation of compounds or condensates having hydroxyl, oxo groups and/or oxo bridges, which may serve as pre-stages. By setting suitable parameters, for example the degree of condensation, solvent, temperature, water concentration, duration or pH value, it is possible to achieve a sol that can be used as lacquer. Further details of the sol-gel process are described, for example, in C. J. Brinker, G. W. Scherer: “Sol-Gel Science—The Physics and Chemistry of Sol-Gel Processing”, Academic Press, Boston, San Diego, New York, Sydney (1990).

The lacquer used according to the invention usually contains a solvent or dispersant that can be selected depending on the system used. Examples of such usable solvents or dispersants that can also be used in the above-described sol-gel process, are water, alcohols, for example lower aliphatic alcohols (C₁-C₈ alcohols) such as methanol, ethanol, 1-propanol, i-propanol and 1-butanol, ketones such as acetone and methyl isobutyl ketone, ethers such as diethyl ether, glycols, glycol ethers, esters such as ethyl acetate, amides such as dimethyl formamide, sulfoxides and sulfones, and their mixtures. Organic solvents that can be mixed with water are particularly suitable.

The lacquer comprising glass or glass-forming pre-stages may be, for example, a suspension of a glass powder in a suitable solvent, which glass powder consists, e.g., of microscopic or submicroscopic glass particles. A sol generated through the hydrolysis and/or condensation of suitable hydrolysable compounds, e.g. preferably in the above-described sol-gel process (sol-gel lacquers), may also be used as lacquer. True solutions of glass compositions, in particular of sodium silicate, may also be used as lacquer. Any type of sodium silicates can be used.

Such lacquers comprising glass or glass-forming pre-stages are known. Examples of sol-gel lacquers or coating systems for glass-like layers are described, e.g., in DE-A-10059487, DE-A-19647368 or DE-A-19714949, and reference is made to the entire contents of the same.

DE-A-19714949 describes, e.g., a coating composition for the production of glass-like layers that can be obtained by a process comprising the hydrolysis and poly-condensation of one or more silanes of the general formula RₙSiX₄₋ₙ, wherein the X groups—which are equal to, or differing from each other—are hydrolysable groups or hydroxyl groups, the radicals R—which are equal to, or differing from each other—stand for hydrogen, alkyl, alkenyl, and alkynyl groups having up to 4 carbon atoms, and aryl, aralkyl, and alkaryl groups having from 6 to 10 carbon atoms, and where n means 0, 1 or 2, provided that at least one silane with n=1 or 2 is used, or oligomers derived therefrom, in the presence of nanoparticulate SiO₂ particles and/or at least one compound from the group of oxides and hydroxides of the alkali and alkaline earth metals.

Another example is the use of the compositions (nanocomposite sol) described in DE-A-19647368 as glass-forming pre-stages. In that system, the colloidal inorganic particles, in particular SiO₂, and the silanes mentioned constitute the glass pre-stage.

These lacquers may contain additional additives for modifying the wetting and flow behavior or for stabilizing the yet uncompressed glass-like layer. Examples of suitable additives are organic binders, wetting additives, wetting agents, leveling agents, tensides, viscosity enhancers and stabilizers. During subsequent thermal treatment, these additives may either be burnt out or incorporated in the glass-like layer without prejudicing the desired properties.

Any lacquering method known to a person skilled in the art may be used for coating the substrate with the lacquer in a wet chemical process, preferably the slot injection molding method, application by doctor blade method, dip coating method, roller application method, print coating method or spray coating method.

After the coating application follows a heat treatment to remove any solvents and to then, in essence, thermally compress the coating completely. From experience we know that this requires temperatures of more than 200° C. The temperature used for thermal compression may vary largely and is determined, in particular, by the selected combination of substrate and glass-like layer to be formed. Especially when using polymeric temperature-resistant substrate temperatures in a range between 250° C. and 450° C. are preferred for thermal compression, and particularly preferred are temperatures in a range between 300° C. and 400° C. For other substrates, temperatures of more than 500° C. can be used. In the below example 1, e.g., temperatures ranging from 400° C. to 560° C. are expedient for thermal compression.

During heat treatment, heat may be applied by way of a hot air or gas stream, infrared heating, inductive or resistive heating of the substrate in case of a conductive substrate such as a metallic substrate, or by way of heated rollers. When using a heated roller, contact may be established directly via the coating or by the substrate.

In order to reduce the number of defects it may be expedient to repeat s the application of the glass-like layer several times alone without thermal compression or even the combination of layer application and thermal compression.

The thickness of the thus produced glass-like layer may vary largely, but normally it will be between 50 nm and below 10 μm, preferably between 200 nm and 5 μm, particularly preferably between 300 nm and 3 μm.

In a next step, the carrier material made of plastic is applied onto the glass-like layer while the latter is still on the temperature-resistant substrate, and is bonded to the glass-like layer. Plastic is an organic polymer. The polymeric carrier material forms a transparent layer. Examples for suitable organic polymers are polyethylene terephthalate (PET), polyester, polyethylene naphthalate (PEN), polycarbonate and cellulose acetate.

The polymeric carrier material can be applied and bonded to the glass-like layer in different ways. For example, a plastic dissolved in a suitable solvent can be applied to the glass-like layer by a common coating method, such as application by doctor blade, dipping or spraying, or by any other of the above-described coating methods. After that, it is dried. As an alternative, a reactive mixture of monomers, oligomers and/or polymer resins can be applied and hardened or rather cross-linked in the layer through heat treatment or radiation. During hardening or cross-linking, polymerization and/or cross-linking of the polymerizable or curable groups contained in the reactive mixture takes place by formation of the polymeric carrier layer. The reactive mixture may possibly contain suitable initiators.

Another option is to apply a thermoplastic polymer by way of extrusion. Finally, a transparent polymer film can also be laminated onto the layer, whereby the compound is bonded by an adhesive or adhesive layer. In the latter case, any polymer film known to a person skilled in the art may be used, for example a polymer film made of polyester, such as PET or cellulose acetate. Transparent adhesive foils may be used that comprise a polymeric carrier layer and an adhesive layer. Such adhesive foils are commercially available.

The adhesive or adhesive layer may be a reactive adhesive based on, e.g., epoxy or acrylic ester, a contact adhesive based on, e.g., natural rubber or a heat-seal adhesive. During lamination the adhesive layer may be optionally applied onto the glass-like layer or onto the polymer film, or onto both. As an alternative, a suitable heat-seal foil may be used.

In a last step, the composite is separated from the temperature-resistant substrate, which can be done e.g. mechanically or chemically. Mechanical separation means, for example, that the film composite is simply peeled off the substrate. In the case of chemical separation, the temperature-resistant substrate is dissolved with a suitable etching agent. The substrate can be removed through chemical or electrolytic etching. Of course, attention must be paid that the composite film is not damaged in the process.

The above-described process can be carried out discontinuously in batches. However, a continuous process, e.g. from roll to roll, is just as possible, whereby the individual steps may be carried out separately or even integrated into one single overall process.

The process can be complemented by applying one or several additional layers on either side of the composite film, for example in order to seal any still existing defects, to protect the glass surface or to change surface properties for further processing. The additional layers can be applied by coating or laminating. This way, one can generate barrier films with complex structure.

With the process according to the invention, one can easily produce flexible, gastight and transparent composite films that have a glass-like layer for a barrier layer. The glass-like layer rests on the polymeric carrier layer, whereby the composite may possibly be facilitated by an adhesive or an adhesive layer.

The composite film obtained in this way is suitable as encapsulation material or packing material, for example for rigid or flexible (e.g. rollable) products. It may also be used in displays, illumination (“illuminated wallpaper”) and photovoltaics, and for encapsulating or packaging large-scale, rigid or flexible air-sensitive or moisture-sensitive optoelectronic components, in particular inorganic and organic light-emitting diodes, solar cells and displays or display components, or electronic circuits.

The invention is described by the following examples, which are not meant to constitute any kind of limitation.

### EXAMPLE 1

A sodium silicate sol was produced as follows according to the provision set forth in DE-A-19714949. 25 ml (124.8 mMol) of methyltriethoxysilane (MTEOS) were stirred overnight (for at least 12 hours), at room temperature, with 7 ml (31.4 mMol) of tetraethoxysilane (TEOS) and 0.8 g (20 mMol) of sodium hydroxide, until the entire sodium hydroxide dissolved and produced a clear yellow solution. Then 3.2 ml (177.8 mMol) of water are slowly added at room temperature, whereby the solution heats up. After the water is added in full, the clear yellow solution is stirred at room temperature until it has cooled down, and after that it is filtered through a filter having a pore size of 0.8 μm.

The sodium silicate sol thus obtained was then applied onto a 12-μm thick aluminum film by way of an application via the doctor blade method in a continuously working film coating system. Segments of the film where then compressed in a muffle-type furnace at 500° C. A layer of a commercially available epoxy resin adhesive was applied via the doctor blade method onto a polyethylene terephthalate film (PET film), and the coated aluminum film was laminated against it. After hardening of the epoxy resin, the aluminum film was dissolved in 15-percent hydrochloric acid. The result is a flexible, transparent composite film of the PET film and a continuous sodium silicate layer.

### EXAMPLE 2

A polyimide film was first coated with a thin, porous SiO₂ layer precipitated from a sol obtained by the Stöber method. This layer serves as a separation layer after thermal compression. Onto this layer another thin layer was precipitated from an ethanolic suspension of nanoparticulate hydroxylapatite, which enhances the wetting of the subsequent glass-layer. Finally, for applying the glass layer an ethanolic suspension of a commercially available, finely powdered lead borate glass solder was used. For all previous coating steps, a roller dipping method was used. The coated polyimide film was thermally treated at 375° C., whereby the glass solder powder melts into a continuous layer.

In the simplest case, the thus produced glass coating on the polyimide film could be peeled off with a transparent adhesive tape, which would produce a composite according to the invention. A much better quality was achieved through lamination onto PET film by using a commercially available epoxy resin. After it hardened, it was possible to peel off the polyimide film, which produced a dense composite between the PET carrier film and the glass layer.

1. Method for the production of a composite film, comprising a transparent carrier layer made of plastic and a glass-like layer, wherein
(a) a temperature-resistant substrate is coated with a lacquer comprising glass or glass-forming pre-stages by a wet chemical process,
(b) the thus obtained coating is thermally compressed to form the glass-like layer,
(c) the transparent carrier layer made of plastic is applied onto the glass-like layer and bonded thereto,
(d) the composite of the carrier layer and the glass-like layer is separated from the substrate.

2. The method of claim 1, wherein the temperature-resistant substrate is a rigid substrate or a film.

3. The method of claim 2, wherein the rigid substrate is a plate or roller.

4. The method of claim 1, wherein the substrate is a high temperature resistant polymer film, a metal film or a rigid substrate made of metal, glass, ceramics or high temperature resistant polymer.

5. The method of claim 4, wherein the high temperature resistant polymer film is a polyimide film.

6. The method of claim 1, wherein the substrate is coated with a coating that facilitates separation of the substrate from the glass-like layer and/or wetting of the substrate with the glass-like layer before and during compression.

7. The method of claim 1, wherein the lacquer comprising glass or glass-forming pre-stages is a i) suspension of a glass powder, ii) a sol made of glass-forming pre-stages, generated through the hydrolysis and condensation of hydrolysable compounds, or iii) a solution of a soluble glass composition in a solvent.

8. The method of claim 1, wherein the lacquer comprising glass or glass-forming pre-stages comprises one or several additives selected from organic binders, wetting additives, wetting agents, leveling agents, tensides, viscosity enhancers and stabilizers.

9. The method of claim 1, wherein the lacquer comprising glass or glass-forming pre-stages is applied onto the substrate by a slot injection molding method, dip coating method, application by doctor blade method, roller application method, print coating method or spray coating method.

10. The method of claim 1, wherein for applying and bonding the transparent carrier layer made of plastic to the glass-like layer
c1) a coating composition comprising an organic polymer in a solvent is applied onto the glass-like layer and dried,
c2) a coating composition comprising one or more polymerizable or curable organic monomers, oligomers or polymer resins is applied onto the glass-like layer and hardened,
c3) a thermoplastic is applied onto the glass-like layer by way of extrusion, or
c4) a plastic film is laminated onto the glass-like layer with the aid of an adhesive.

11. The method of claim 1, wherein the composite film is separated from the substrate by
d1) separating the composite comprising a carrier layer and a glass-like layer from the substrate by peeling it off mechanically, or
d2) by removing the substrate through chemical or electrolytic etching.

12. The method of claim 1, wherein one or more additional layers are applied onto the composite film through coating or laminating.

13. A composite film, comprising a transparent carrier layer made of plastic and thereon a flexible, thermally compressed glass-like layer.

14. The composite film of claim 13, obtainable by a method for the production of a composite film, comprising a transparent carrier layer made of plastic and a glass-like layer, wherein
(a) a temperature-resistant substrate is coated with a lacquer comprising glass or glass-forming pre-stages by a wet chemical process,
(b) the thus obtained coating is thermally compressed to form the glass-like layer,
(c) the transparent carrier layer made of plastic is applied onto the glass-like layer and bonded thereto,
(d) the composite of the carrier layer and the glass-like layer is separated from the substrate.

15. The composite film of claim 13, wherein the thickness of the glass-like layer will be in a range between 50 nm and below 10 μm, preferably in a range between 200 nm and 5 μm.

16. The composite film of claim 13, wherein the transparent carrier layer and the glass-like layer thereon are connected to each other by way of an adhesive.

17. Use of the composite film of claim 13 as encapsulation material or packaging material.

18. Use of the composite film of claim 13 for encapsulating optoelectronic components, such as photovoltaic cells, organic and inorganic light-emitting diodes for illumination purposes and for display applications, displays and display components and electronic circuits.
